(19) United States
(12) Patent Application Publication
(10) Pub. No.: US 2025/0180219 A1
(43) Pub. Date: Jun. 5, 2025

(54) A Packaged Food Heating Device

(71) Applicant: FASE Vending, LLC, Wyncote, PA (US)

(72) Inventor: Gregory Raffaele, Wyncote, PA (US)

(73) Assignee: FASE Vending, LLC, Wyncote, PA (US)

(21) Appl. No.: 18/843,406

(22) PCT Filed: Mar. 7, 2023
(86) PCT No.: PCT/US2023/014736

§ 371 Date: Sep. 3, 2024

Related U.S. Application Data
(60) Provisional application No. 63/317,146, filed on Mar. 7, 2022.

(51) Int. Cl. F24C 7/04; A47J 36/32; A47J 37/06; B66F 7/06; F24C 7/08; F24C 15/16; F24C 15/32; H05B 3/00

(52) U.S. Cl. CPC F24C 7/043; A47J 36/32; A47J 37/0641; A47J 37/0658; F24C 7/081; F24C 15/16; F24C 15/325; H05B 3/0076; B66F 7/065

(57) ABSTRACT

The invention relates to a system, methods and apparatus for efficiently and cost-effectively processing and heating with a food heating device for self-service and/or fully automated applications that would involve a Grab and Go packaging, This food heating device includes a closed oven self-heating or cooking chamber containing a series of halogen heating units together with one or more controlling fans. The oven incorporates halogen lamps to heat-up the top and at least 1 fan along with a suction means to create a path for movement of the hot air within the oven and back inside. It would also include an automated riser to elevate a take-out container. Containers, such as but not limited to aluminum are situated alongside the device to receive the processed food item. For example, a corrugated box bottom elevates the item. In one embodiment the food item is elevated and slowly spins independently on its own using the power of the fans, or mechanically using a motor, or in combination of both to provide uniform cooking from an internal space within the housing

### CROSS REFERENCE TO RELATED APPLICATIONS

This application is the US national application of PCT/US2023/014736, filed 7 Mar. 2023, which claims benefit of and priority to U.S. Provisional Patent Application No. 63/317,146, filed 7 Mar. 2022, where permissible incorporated by reference in its entirety.

### FIELDS OF THE INVENTION

The present invention relates to a heating and cooking device, and more particularly to a food preparation device used by an individual or consumer in the preparation. More specifically, the present invention relates to heating or cooking food stored in a packaged container for convenient and inexpensive preparation by direct contact with an internal infra-red halogen heat source.

### BACKGROUND

### Description of Related Art

Current food heating devices include halogen-based ovens, air-fryers, and electric cookers. These food heating devices are respectively suitable for certain types and ranges of foods, but at the same time have limitations. For example, although being convenient for heating various types of food, such that heated food becomes drier and taste of the food may be affected.

Other limitations in prior food heating devices are that they require the food product to be removed outside their container to be cooked or warmed up where there is a possible risk of food contamination and/or non-respect of commercial food safety standards. On the other hand, halogen when controlled by directing internal air streams in heated food decrease the time needed for heating.

In a conventional or convection oven, often the food at the edges and corners are overheated and sometimes burnt, lowering the overall quality of the prepared food usually because the food product at the edges and corners is getting heated from 2 or 3 sides and at the same time is close to the surfaces. In conventional or convection ovens, there is no way, for the most part, to lessen the amount of heat to these edges and corners or to control different amounts of heat to different regions of trays, except to change to more complicated and expensive packaging. Thus, it would be desirable to have a heating method whereby the amount of heat can be controlled to a lower amount in a relatively small device that allows the immediate cooking area to avoid overheating and burning.

With food preparation devices, food may usually come in large-size frozen portions. As a matter of example, a standard “half-pan” lasagna packaged in an aluminum tray requires about 1950 kJ of energy and may take more than 125 minutes in a conventional oven to be heated from frozen to an acceptable hot temperature for serving. Consumers and individual operators are less inclined to accept such long heating times. One possibility is to divide the food in several smaller portions which are put in smaller containers, trays or dishes. However, this is labor intensive and it requires more attention from skilled operators. Therefore, there is a need for conveniently, rapidly and cleanly heating or cooking food originally packed in medium to large size packages without the requirement to remove the food from their packages to reduce the labor and easily transfer the food to the consumer in hot conditions.

The packaging of the food is limited to things such as aluminum or plastic that may require a special liner. Therefore, it would be desirable to provide a device that is quicker, simpler and reasonably low in cost, small and portable in some situations, and easy to use. Heating/cooking appliances have been described which are designed for heating different food containers such as dishes or pans. However, the heating capacity of those warming devices is limited as the energy loss to the environment which is high due to an open configuration. Thus, most heating devices are generally used just for heating small size portions either from ambient to warming to cooking but they are not capable of handling the heating of large portions of food, especially, when the food is originally in frozen or in a chilled state in the plate. For instance, U.S. Pat. No. 3,043,943 to J. R. Moot relates to a portable food warmer, and more particularly to a tray adapted to heat food and dishes containing food to serving temperature.

U.S. Pat. No. 3,608,627 relates to a combination refrigeration and cooking device. A plurality of casseroles are provided into a freezing or chilling chamber. Each casserole has an electric heating element associated therewith which is connected to an electric circuit controlled by suitable switching and/or timing means. Each casserole has a cover and an associated heating element which form a complete thermally insulated unit. The thermally insulated unit reduces the heat loss of internally produced heat so that there is no significant loss of heat to thermally affect adjacent casseroles. Such a device is not adapted to heat packaged food. Furthermore, the heating casseroles need to be regularly removed for cleaning and/or washing which may lead to potential safety issues since the casseroles also include electrical means.

U.S. Pat. No. 5,445,062 relates to a cooker/rethermalizer especially suited for cooking or reheating of prepared, packaged meat and sauce entree items or vegetables comprising a food vessel retaining an aqueous bath, a food locator rack for supporting packaged food items and fluid outlets provided in the rack to cause fluid to exit into the bath and agitate the bath over and past food items. Such a heating apparatus is suited to accommodate flexible film packages, so called “sous vide” packages. However, the system is relatively cumbersome and requires a relatively long preheating time for the bath to be operational.

U.S. Pat. No. 5,948,301 relates to a food thermalization device which permits the food to be re-thermalized and held warm which includes an electrically-resistance heated plate which is controlled to equilibrate at a set temperature in the range of 160° F. to 185° F.

U.S. Pat. No. 5,069,920 relates to a method of electric conduction cooking of food in a package. The package includes two electrodes including a raised portion of the bottom wall and a planar top electrode. The food is cooked by passing electrical current through the food and allowing the drainage and accumulation of exuded products from the food product being cooked so as to prevent contamination of the bottom electrode. However, the heating greatly depends upon the electrical conductivity of the food. As the electrical conductivity of the food product may also differ from frozen state to thawed state, and as a function of temperature, the heating pattern is difficult to control accurately. Furthermore, shock hazards are greatly increased when current is passed through the food itself whatever efforts are made to diminish the risks.

U.S. Pat. No. 4,102,256 relates to a cooking apparatus for use in conjunction with food which is held in a container whereby, thin-walled flexible members defining the cooking surfaces are thermally coupled to heating means maintained in position against the thin-walled flexible members by maintaining means.

Therefore, there is a need for heating, and possibly holding hot, packaged food in relatively smaller, simpler, safer and more convenient ways using relatively low power requirements as compared to existing foodservice or even household ranges. There is also a need for efficiently and evenly heating food packaged in the standard container, in particular, aluminum lidded tray, or other differing packaging without the requirement of removing the food from the container to facilitate heating of the food to deliver the intended temperature and quality. There is also a need for controlling the heating of the food so as to optimize the heating time and reduce the risk of over heating and burnt food surfaces.

### SUMMARY

The present invention incorporates an improved conventional halogen infrared radiation cooker to provide a modified, uniform air flow within a cooker having a dome-shaped hood and an elevation system for raising or lowering a supporting tray to separate a food item from the heating source, either with a columnar scissor mechanism or alternatively a central piston mechanism. Uniform radiant halogen heat and air flow from an internal fan design allows the food item to cook from above and below on the elevated supporting platform when the dome is secured in the closed position. This internal heating design allows for uniform and quick cooking time which also reduces the further burden of any turning of the food over excessively.

Embodiments of the present invention are shown in the drawings and summarized below. It is to be understood, however, that there is no intention to limit the invention to the forms described in the specification. One skilled in the art can recognize that there are numerous modifications that would embody the spirit and scope of the invention as expressed in the claims.

### DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein.

FIG. 1. (A) Front view of the box with the inner dome chamber of the heating area having halogen lights and positioned fan, representing the central piston elevation system. (B) Side view showing hot air flow within the chamber during cooking each arrow indicates hot air flow direction generated by a single fan within the upper dome area, depicting the columnar scissor elevation system for the food item tray.

FIG. 2. (A) A schematic representation of the cooking device having lamps along the inner surface mounted to optimize heating of the food item in the central piston elevation system. (B) Louver placements along the hood side, back, and top for regulating air flow in both elevation systems.

FIG. 3. Perspective views of the cooking device in versions having the columnar scissor elevation system. (A) Front view with container tray and food item inside showing open position of access portal window. (B) Front view showing transparent frame with container tray and food item on the support platform shown in the window in the “insert box” position by elevating scissor component. (C) Transparent side view with hood holding dome above food while in the closed position during cooking. Fan blade and lamps not shown. (D) Transparent front and side view further showing dome in the closed cooking position with elevating scissor component in lowered position. (E) Transparent side general view of oven in open position either after cooking before tray removal, or before cooking before closing position.

FIG. 4. A side view representation of the central piston elevation system having a tray inserted in the oven (lid open) in a non-elevated position along the bottom surface before heating (A). The same view shown after elevation of the food item during heating in an elevated position (B). The food item is elevated outside and above the tray for heating and to separate the tray away from the heat zone.

FIG. 5. Drawings views of (A) the storage lid of the storage container for a food item before or after cooking showing the top, side and bottom, limited to the cooking device version having the columnar scissor elevation system and (B) representation of the food item container or base which is used with the corresponding tray having typically four holes on the bottom surface to allow the columnar pillars to pass through the tray and allow the tray to move vertically up or down in a rising or lowing motion.

FIG. 6. Storage container boxes used with the cooking device having the central piston elevating system. (A) Open container for elevating with piston having a centered base to raise or lower into the heating zone and (B) an alternative central piston design.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “compromises” and/or “compromising,” when used in this specification, specify the presence of stated, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those used in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specifications and claims should be read with the understanding that such combinations are entirely within the scope of the invention and claims.

The present invention is described referencing the appended figures. Although described with particular reference to a food heating/cooking device, the device has application by individual consumers or possible professionals to allow an easy, simple method for preparing packaged food items using a cost-effective appliance.

The present invention provides for a low-cost quality food heating device that allows for uniform heating or cooking of a packaged food item within an insulated inner box or package housing having an inner support platform to position the food item without the need to manipulate the food item outside of its packaging. The oven design is combined with a series of halogen lamps oriented within an internal space and along the upper inner surface of the dome housing to rapidly heat-up the top with at least 1 fan oriented within the top of the inner dome-shaped hood to regulate the internal movement of heat. A food item is positioned on an internal tray or support platform elevated or lowered through a scissoring structure to allow at least three but preferably four columnar pillars to support the food item during heating/cooking. A further embodiment provides a central piston to elevate or lower the food item when positioned on the tray. When elevated appropriately for cooking, directional hot air flow across the upper and lower portions of the food item is uniformly heated at the same time thereby reducing overall cooking time and ensuring complete uniform heating which also improves the flavor and taste of selected food items incorporating this process.

The above cooking device is suitable, in part, for direct consumer use and offers easy benchtop installation for purchase in most retail consumer markets.

As stated above, the halogen oven features the lamps within a dome-shaped chamber consisting of the heating assembly. Inside the chamber, a platform area provides support for the packaged food which sits elevated on supporting pillars to allow continued air flow within the contents during the cooking process. Within the chamber's dome one embodiment of the heating assembly contains at least one halogen lamp, a fan, and controls for maintaining settings ideal under oven conditions which may optionally include an automatic shut-off timer and a temperature control interface. The oven can be manually or automatically opened by the consumer to insert the packaged food and is coupled to a coordinated scissor movement to rise and lower simultaneously a supporting platform and the heating assembly dome. Optionally, a safety shut-off switch turns off the lamp when the oven is raised during operation.

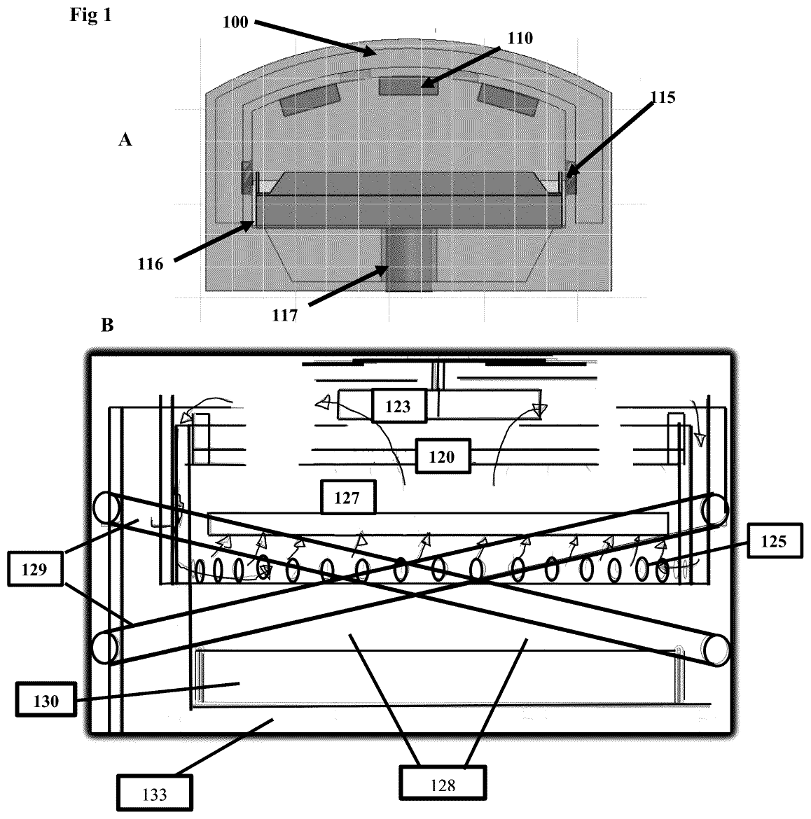

In one embodiment shown in FIG. 1A of the cooking device, 100, having a series of halogen lamps, 110, with fans, 115, on each side but any number of fans in multiple locations has been contemplated in the present invention. Cooking device, 100, incorporates a food item support tray, 116, to allow a central piston elevating system, 117, to independently raise or lower the food item positioned on a base.

Another embodiment shown in FIG. 1B of the present invention considers a design with at least one fan above the packaged food support platform while cooking to provide suction and air flow through a series of specifically arranged access holes to control hot air from underneath the food and provide uniform air movement as shown in the schematic representation of FIG. 1B having a columnar scissor elevating structure. Hot air from the infra-red lamp, 120, is directed up from the food by a single fan, 123, above three or more, preferably four, pillars, 128, to allow the food item to be cooked, as for example with a pizza, 127, within the cooking area. As shown with the directional arrows in FIG. 1B, Air flow is directed along the sides of the inner chamber through holes, 125, to blow hot air from underneath the food as it is supported on the pillars, 128.

A further suction means or multiple suction means provide a rapid increase or decrease in chamber temperature specifically in the upper region to create a path for hot air movement within the oven and then back inside. Also shown are one elevating scissor component, 129, which previously simultaneously lowers the platform, 133, with the tray/box, 130, and the heating assembly dome.

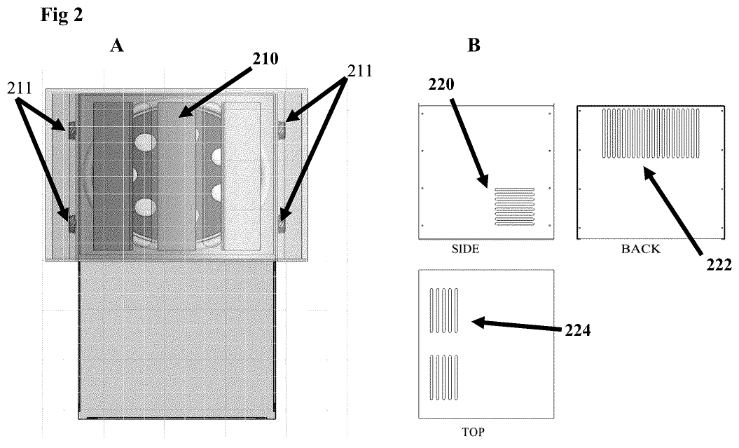

FIG. 2 A of the cooking device having the embodiment with the central piston elevating system shows a top perspective view above the halogen lamps, 210, along the upper inner surface and positioned or angled downward to provide improved universal heating. In a further optional configuration, a series of side mounted fans, 211, ensures universal air movement around the food item. The present invention also considers allowing the platform to rotate for better heating uniformity. Controlled dissipation of heat generated during cooking and allowing continued cooling for the electronics with the strategic placement of selected louvers on the outer facing regions of the hood is shown for both embodiments in FIG. 2 B which depicts a series of louver panels on the hood side, 220, back, 222, and top, 224, respectively. These locations provide ventilation to allow the hood to vent excess heat from the device.

Thus when the packaged food is secured on the top piston in the central piston elevation system or on the pillars in the columnar scissor system, the lamp is turned on by a thermostat or electronic control to generate waves of infrared light which heats the air within the heating chamber. The fan then circulates this heated air throughout the chamber to evenly cook the food item contents through convectional air flow movement.

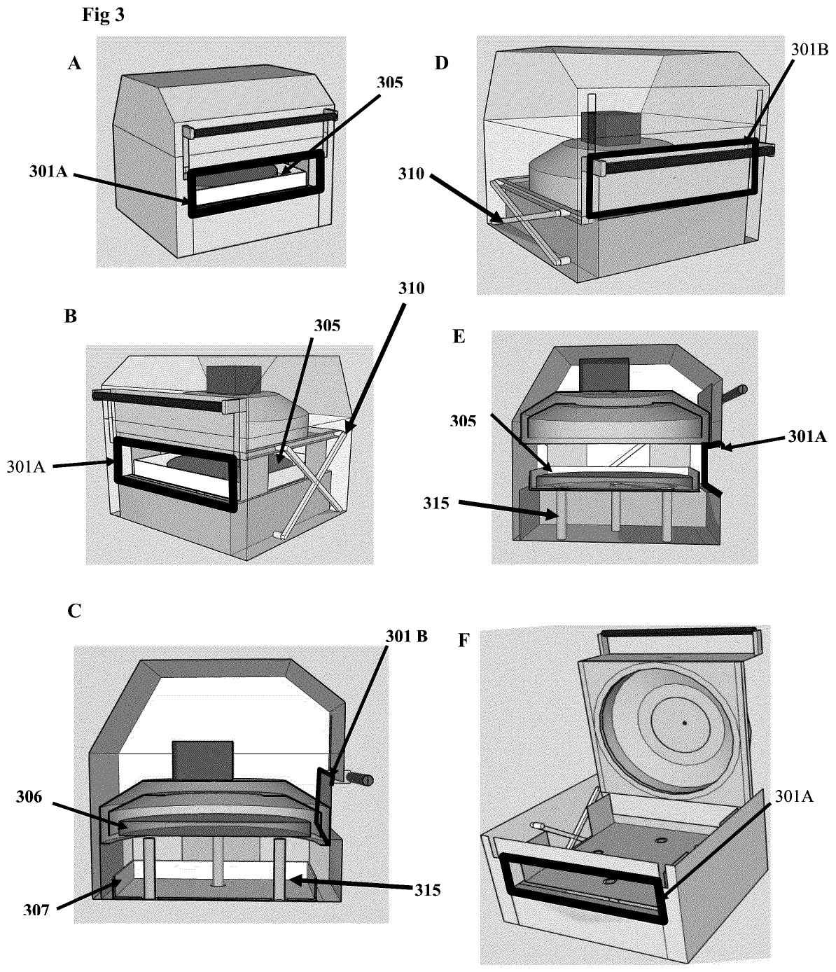

As shown in FIG. 3B and FIG. 3D, the scissor elevating system allows for elevating or lowering the support tray, accomplished through a scissoring mechanism, 310. In fact, FIG. 3 A-B-C-D-E-F are various representations of the embodiment for the columnar scissor elevating system.

FIG. 3A depicts the front face with the “insert slot”, 301A, in an opened position and having a typical packaged food item, 305, platform after insertion. A manual handled on the front face, or an automatic mechanism allows the opening or closing of the insert slot of the package food item. FIG. 3 B shows a side view of the food item positioned with the insert slot opened, 301A, and the heating assembly dome positioned above the food item by the elevating scissors, 310. The packaged food item, 305, is supported by both the platform (to support the tray/box), and the pillars, 315, further depicted in FIG. 3C and FIG. 3E to support the food item. FIG. 3 C shows the food item positioned with the insert slot closed, 301B, and the heating assembly dome positioned around the food item by the elevating scissors, 310, for uniform cooking. The tray/box, 307, was positioned at the lower level by the elevating scissors to keep the package away from the heat zone, while the food item, 306, stayed in the same position using the pillars, 315, with the heat assembly dome having the halogen lamps and fan (not shown) to generate the specific heat movement for cooking to allow directed air flow across the food from below. An upper fan circulates air flow above and below the food item. FIG. 3 D represents one side view of the elevating scissors with the insert slot in a closed position also showing the position of the scissor component, 310, and the heat assembly dome lowered around the food item. The tray/box and platform were not depicted on FIG. 3D but were positioned at the lower level in the same movement that lowered the heat assembly dome around the food item utilized by the scissor mechanism. The access portal window, 301B, is shown. FIG. 3 E is yet another view of the insert slot opened with the heating assembly dome above the packaged food item which can be either before cooking and after the packaged food item being inserted, or after cooking is finished and the packaged food item is ready to be picked-up by the consumer. The food item can be supported by the pillars directly or a layer, such as but not limited to parchment paper or disk or other open-top container shape with or without edges constructed of aluminum or any other appropriate material typically capable of withstanding the internal heat temperatures. In the case of a layer, disk or other open-top container shape, the pillars would not be in direct contact with the food item.

It is noteworthy that in still another embodiment, FIG. 3 (F), the hood can be opened for cleaning purposes.

Heating or cooking temperatures range from approximately 150 degrees to 550 degrees Fahrenheit depending on the selected protocol for the device. FIG. 3F shows the cooking unit with the hood open and the support platform exposed for easy cleaning. However, the temperatures generated with one or more halogen heating elements must be compatible with a single-phase 20 amps, and a maximum 250 v electrical system of the device. The entire unit must be compatible with electrical wiring in a home or small business facility.

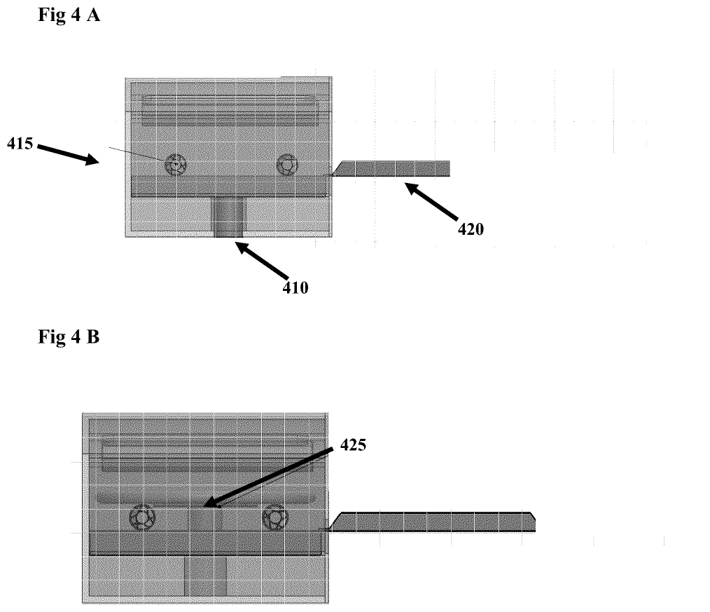

Alternatively, as shown in FIG. 4A with a representation of the central piston elevating version, a side view representation having a bottom support and a piston riser, 410, to raise the food to the upper heating region or above the fans when activated. When the desired temperature and time are complete, the riser lowers the bottom support to an access position with a corrugated box, 420, along one side of the bottom edge with the elevated bottom surface. FIG. 4A provides a non-elevated representation, 415, after or before the heating process whereby the food item is to be elevated and repositioned. FIG. 4 B represents the food after the elevation rise. A piston raises the food item to be heated. Once elevated the food item supported by the piston platform, or a layer, disk or other open-top container shape with or without edges may but necessarily optionally slowly spin according to a predetermined cooking protocol, either automatically on its own using each designated fan as a means to uniformly heat the food item or optionally to rotate or mechanically rotate, 425, cooking of the food item. Rotation is obtained through self-propelled air from the fans or an internal motor means or a combination of both is considered. This motion allows for a preprogramed temperature and time period to warm or complete a uniform cooking protocol.

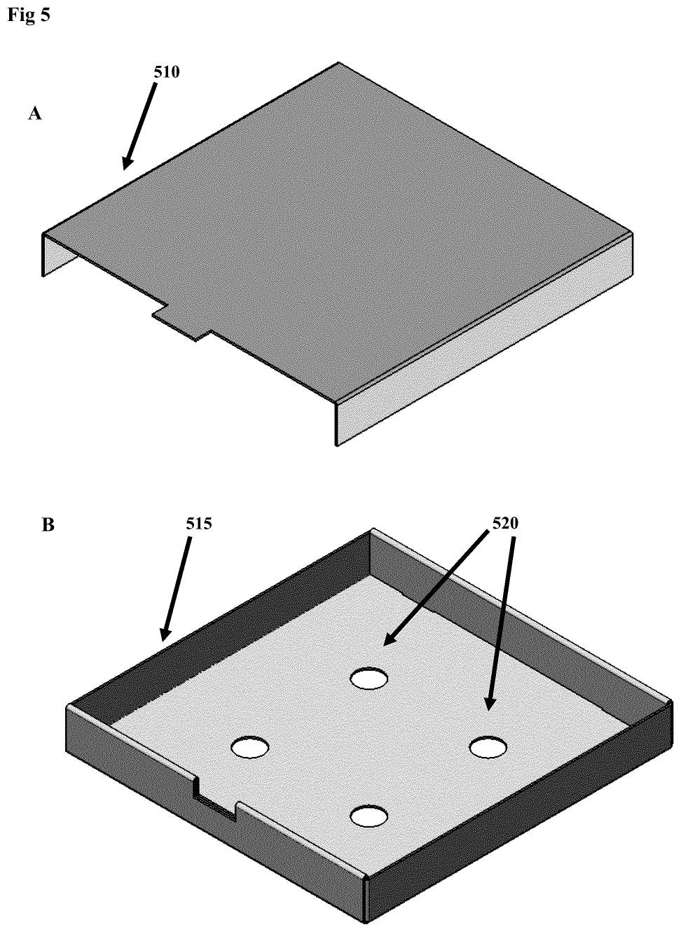

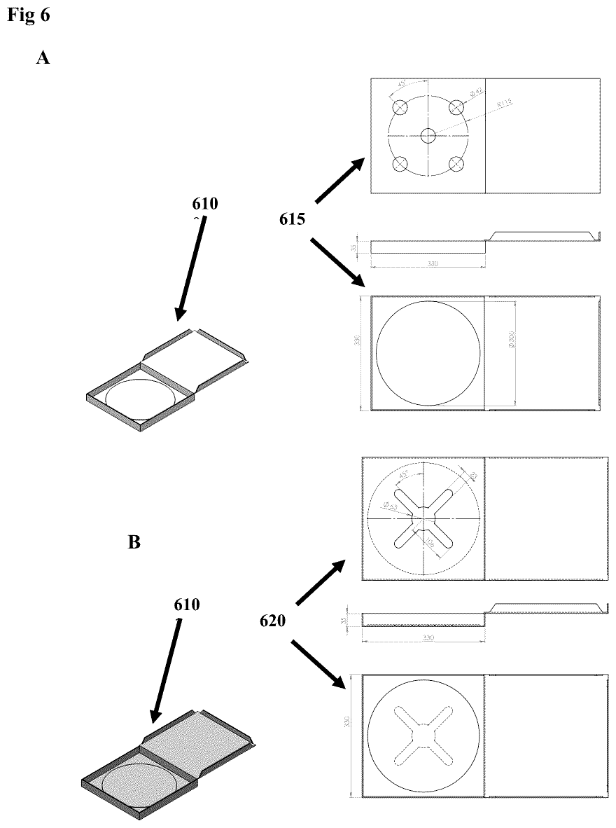

A still further embodiment of the present invention is the incorporation of a packaging means to compliment use with the heating device as shown in FIGS. 5 A and B in the columnar scissor elevation system, and in FIG. 6 central piston elevating system. When heating specific food items, a packaging means consisting of a detachable 2-part box package with a lid, 510, and based containing support side structures, 515, incorporated a box design to protect the food item from external elements and preserve the food for logistical and/or storage purposes, compatible for “Grab & Go” consumer needs. The lid and base for the box contain a notched support lock to secure the lid and prevent potential movement during the package manipulation. The optional layer, disk or other open-top container shape with or without edge is made of various food-contact approved material, such as but not limited to aluminum or PTFE cookware or any other fiber composition appropriate for heat transfer. The box can be of any size, optimally at least 5 inches in width or length or diameter and any shape whether round, rectangular oval or a combination thereof.

The food item fits in the box to cover up a series of at least one hole in the central piston elevating system version and at least three holes, preferably four holes, for the columnar scissor elevation system version. FIG. 5 B depicts the preferred four holes, 520, to be compatible with the 4 pillars used in this version and to allow the platform to lower and elevate the tray/box and the pillars for passage through these holes so to support the food item. Any arrangement of hole patterns or similar functioning design to support a food item in the bottom is considered with this version which allows the food item to be held for cooking while the support base, 515, is lowered and separated via the scissor structure. When cooking is completed, the mechanism then regroups the food item to its package for the consumer to grab hot food in a proper package.

A still further option is to incorporate a pizza stool or pizza saver insert within the box (not shown) to prevent contact with the inner box lid, 510, which can prevent contact with melting cheese. The box may include a flat disk for pizza-like food items. An alternative design is shown in FIG. 6A,610, and FIG. 6B,610, for the central piston elevating system version wherein the box is shown with several designs for the central piston, 615, 620.

In yet another alternative embodiment, the present invention can be used in an automated system for cooking. The cooking device of this invention comprises an electronically controlled processor means interfaced with the heating and fan components for cooking food and comprises sensors within the dome portion of the chamber into which food is placed within a heat source for providing heat to the food in the dome and containing a control system for operating the heat source in successive time-based cycles over a duration of holding times to heat food in the dome according to a predetermined program or protocol. The control system comprises an algorithm adapted to override the predetermined program and to reduce the heat output of the heat source in the event the amount of energy delivered by the heat source during a reaches or exceeds a predetermined energy limit. The control system then manages the air flow through at least one fan within the dome to maintain the optimum heat output needed for the packaged food to be cooked.

Therefore, a protocol for cooking a specified food item requires the steps of placing food into the chamber of the device, and controlling at least one infra-red halogen heat source in the chamber in successive time-based cycles over a holding period according to a predetermined program or protocol to deliver heat to the food in the chamber. The protocol will further override the predetermined program, reducing the heat output of the heat source and allowing air flow in the event the amount of energy delivered by the heat source exceeds a predetermined energy limit.

Optionally, the program can be further designed to read a predetermined barcode insert on the food packaging that provides the processor with instructions for heating or cooking the prepackaged food item.

The terms and expressions used herein have been used as terms of description and not of limitation, and there is no intention in the use of such terms of excluding any equivalents of the features shown and described or portions thereof. It is recognized that various modification are possible within the scope of the claims. Therefore, it should be understood that although the present invention has been specifically disclosed by preferred embodiments and other features, modification and variation of the invention embodied therein herein disclosed may be used by those skilled in the art, and that such modification and variations are considered to be within the scope of this invention as provided in the following claims.

I claim:

1. A food heating device for cooking a packaged food item by a consumer, comprising:
a. an insulated housing chamber having a dome above a support tray containing a food item;
b. an elevating system to separate the food item or its package from the support tray;
c. at least one halogen heating element within the dome;
d. at least one directional fan to provide uniform air flow interfaced with the halogen heating element; and
e. a portal window for ingress or egress of the food item onto the tray. wherein heating a food item by elevating or lowering the support tray or the food item, allows the consumer to access the packaged food item before and after cooking through a portal window.

2. The food heating device of claim 1 having a columnar scissor elevating system comprising:
a. two scissor structures for elevating and lowering the support tray; and
b. a positioned portal window on the front face of the heating device for access to a food item
wherein the food item is accessible by the consumer when the two scissor structures are lowered.

3. The food heating device of claim 2 wherein a single fan within the chamber provides uniform heat distribution for cooking.

4. The food heating device of claim 2 further having a food item storage lid and base container to allow columnar pillars to provide vertical tray movement.

5. The food heating device of claim 4 having a base container with width and length of 5 inches.

6. The food heating device of claim 2 having at least three support columns to support a food item.

7. The food heating device of claim 2 having four support columns to support a food item.

8. The food heating device of claim 1 having a central piston elevating system.

9. The food heating device of claim 8 having the central piston capable of rotating the food item for cooking within the dome.

10. The food heating device of claim 8 further having an open container box with a circular shape, or any shape that can be supported by the central piston.

11. The food heating device of claim 1 having at least 1 to 50 halogen individual heating elements positioned within the dome.

12. The food heating device of claim 11 wherein the halogen heating elements generate temperatures from approximately 150 to 550 degrees Fahrenheit.

13. The food heating device of claim 1 further compatible with a single-phase 20 amp to a maximum 250 v electrical system.

14. The food heating device of claim 1 having ventilation louver panels on the outer device surface.

15. The food heating device of claim 1 having halogen heating elements controlled by a predetermined heating protocol.

16. The food heating device of claim 1 having directional fans controlled by a predetermined heating protocol.

17. The food heating device of claim 1 further including a cooking sensors for automatically identifying a cooking protocol being used.

18. The food heating device of claim 1 having a consumer interface for selecting a predefined cooking protocol from a processor module.

19. The food heating device of claim 1 wherein the packaged food can be repackaged after cooking to minimize handling and allow further manipulation of the food by the consumer.

20. The food heating device of claim 2 further having a storage lid with a pizza saver.

21. The food heating device of claim 1 wherein the halogen heating element and air flow from the fan are electronically interfaced through predetermined settings for Grab and Go consumer access of the portal window.

22. The food heating device of claim 1 further including a control system for controlling cooking for a food item using at least one halogen heating element and at least one directional fan, the control system being programmed to operate to vary the amount of heat delivered in the dome and to vary the amount of air flow controlled by the fan.
